(19) United States
(12) Patent Application Publication
(10) Pub. No.: US 2009/0056744 A1
(43) Pub. Date: Mar. 5, 2009

(54) WAFER CLEANING COMPOSITIONS AND METHODS

(75) Inventor: Andrew Dennis Watson Carswell, Boise, ID (US)

Correspondence Address: TRASK BRITT, P.C./ MICRON TECHNOLOGY, P.O. BOX 2550, SALT LAKE CITY, UT, 84110, US

(73) Assignee: MICRON TECHNOLOGY, INC., Boise, ID (US)

(21) Appl. No.: 11/847,056

(22) Filed: Aug. 29, 2007

(51) Int. Cl. B08B 6/00; C11D 7/26

(52) U.S. Cl. 134/1.3; 510/175

(57) ABSTRACT

Compositions and methods of removing debris including organic debris from a hydrophobic surface during semiconductor processing are disclosed. The method includes exposing a semiconductor wafer having debris, including organic debris, thereon to a cleaning solution including an oxidizing agent and at least one surfactant.

### FIELD OF THE INVENTION

Embodiments of the invention relate to compositions for cleaning a hydrophobic surface, such as a semiconductor wafer, and to methods of cleaning a hydrophobic surface.

### BACKGROUND OF THE INVENTION

During fabrication of an integrated circuit, a substrate surface, such as a semiconductor wafer often becomes contaminated with debris. The debris may be produced by various processes, such as by abrasive processes, including chemical mechanical planarization (“CMP”). CMP processes are conventionally used to planarize an exposed surface of the semiconductor water upon which semiconductor features, such as interlayer connectors and conducting lines, are to be formed. The surface being planarized may comprise any exposed surface material or materials, such as a metallic material, a dielectric material, or a combination of materials.

During CMP, a polishing pad is pressed against the semiconductor wafer in the presence of a slurry solution under controlled chemical, pressure, velocity, and temperature conditions. The surface material is planarized using a slurry that includes abrasive particles, such as aluminum oxide (“Al₂O₃”) particles, which mechanically remove a portion of the surface material. The slurry may also contain chemical agents in solution that attack the surface material. After processing, the planarized surface is cleaned to remove residual materials produced by the CMP process. The residual materials may include, for example, particles from the slurry solution, organic debris from the polishing pad, and the surface material or materials of the semiconductor wafer. Without cleaning, these particles remain on the substrate surface as contaminants

Conventional post-CMP cleaning techniques or “cleans” include the use of a deionized water rinse followed by a series of cleaning steps which may include a brush box with TMAH and HF. However, conventional post-CMP cleans do not effectively remove all slurry particles and are often ineffective at removing organic debris, which stick to hydrophobic surfaces such as polysilicon. Cleaning hydrophobic surfaces is difficult due to the minimal wetting of such surfaces in an aqueous environment; as a result, organic debris often remains on hydrophobic surfaces after conventional cleaning. Thus, it would be desirable to be able to remove both slurry particles and organic debris from contaminated surfaces, including hydrophobic surfaces, without the need for additional, costly manufacturing steps.

### BRIEF DESCRIPTION OF THE SEVERAL VIEWS OF THE DRAWINGS

FIGS. 1A and 1B schematically illustrate debris on a semiconductor wafer before and after exposure to a cleaning solution according to embodiments of the invention;

FIG. 2 graphically illustrates the amount of contamination on a patterned semiconductor wafer using deionized water in comparison with various cleaning processes according to embodiments of the invention;

FIG. 3 graphically illustrates the amount of contamination on a semiconductor wafer using deionized water in comparison with cleaning solutions including various volumes of surfactant according to embodiments of the invention;

FIG. 4 graphically illustrates the amount of contamination on a semiconductor wafer using deionized water in comparison with cleaning solutions including various volumes of hydrogen peroxide according to embodiments of the invention;

FIG. 5 graphically illustrates the amount of contamination on a semiconductor wafer using deionized water in comparison to cleaning solutions of varying pH according to embodiments of the invention;

FIG. 6 graphically illustrates the amount of contamination on a semiconductor wafer after a 15 second deionized water rinse in comparison with semiconductor wafers exposed, for varying amounts of time, to cleaning solutions according to embodiments of the present invention; and

FIG. 7 graphically illustrates the amount of contamination on bare silicon patterned semiconductor wafer using deionized water in comparison with various cleaning protocols according to embodiments of the invention.

### DETAILED DESCRIPTION

The following description with reference to the drawings provides illustrative examples of compositions and methods according to embodiments of the invention. Such description is for illustrative purposes only and is nonlimiting of the scope of the invention. Other embodiments of compositions and methods may be implemented in accordance with the invention.

The present invention relates to methods of cleaning debris from hydrophobic surfaces such as semiconductor wafers. Debris may be removed by exposing the hydrophobic surface to a cleaning solution including an oxidizing agent and a surfactant. Without being limited to any particular theory, it is believed that the oxidizing agent renders the otherwise-hydrophobic surface hydrophilic, making it easier to remove the debris, and particularly organic debris, from the surface. It is further believed that the surfactant solubilizes the debris which enables the debris to be lifted away from the hydrophobic surface. The surfactant and/or oxidizing agent may also apply a charge to the debris, which enables the debris to be repelled from a similarly charged surface. In addition, when the hydrophobic surface is polysilicon or single crystal silicon, the oxidizing agent will form a surface oxide on the hydrophobic surface which will be removed by a preceding HF clean which undercuts debris on the hydrophobic surface. It will be understood that any combination of the foregoing may occur according to embodiments of the invention.

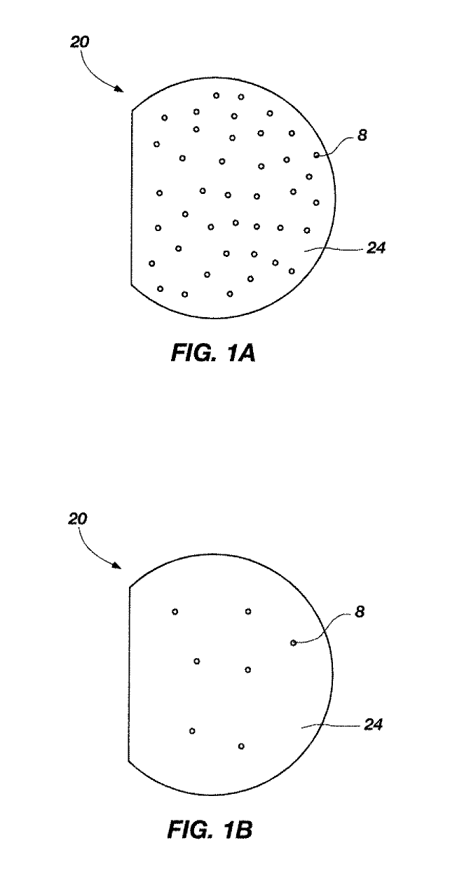

As shown in FIG. 1A, a semiconductor wafer 20 that has been subjected to CMP includes debris 8 thereon. As used herein, the term “CMP” is not limited to chemical mechanical planarization processes but also encompasses other abrasive planarization processes. The hydrophobic surface 24 of the semiconductor wafer 20 that has been subjected to CMP may be any hydrophobic surface 24 that is oxidizable. For the sake of example only, the hydrophobic surface 24 may be a polysilicon material. However, it is understood that the hydrophobic surface 24, the semiconductor wafer 20 and, therefore, the hydrophobic surface 24 formed from semiconductor wafer 20, may be formed from additional materials, such as single crystal silicon or a dielectric resin such as SILK®, available from The Dow Chemical Company (Midland, Mich.). For the sake of example only, the hydrophobic surface 24 may be non-metallic.

At various stages of semiconductor fabrication, the hydrophobic surface 24 may be partially or completely covered with debris 8. The debris 8 may include residual slurry particles from the CMP and particles of the material or materials of the planarized surface, as well as organic debris from a polishing pad used in the CMP. Polishing pads and their use in CMP are well known in the art and may be formed from a soft, porous material, such as an organic polymer. For the sake of example only, the polishing pad may be formed from polyurethanes, polyesters, or other organic polymers. However, the organic debris may also originate from other carbon-containing sources present on the hydrophobic surface 24 being planarized, such as a photoresist material. The cleaning method of the present invention may significantly reduce the amount of debris 8 present on the hydrophobic surface 24.

According to an embodiment of the invention, a semiconductor wafer 20 contaminated with debris 8 may be exposed to the cleaning solution which may be an aqueous solution including an oxidizing agent and at least one surfactant. For the sake of example only, the cleaning solution may be substantially free of ammonia. For the sake of example only, the cleaning solution may be substantially free of hydrogen fluoride. The cleaning solution may be applied to the semiconductor wafer 20 by spin-cleaning, immersion cleaning or by spray-cleaning, as described in detail below. The oxidizing agent may be present in the cleaning solution at from approximately 1 percent by weight (“wt %”) to approximately 5 wt % of a total weight of the cleaning solution. The oxidizing agent may be any conventional oxidizing agent including, but not limited to, periodates, perbromates, perchromates, pernitrates, perchlorates, hydrogen peroxide, organic peroxides, and persulfates.

The surfactant may be present in the cleaning solution in an amount ranging from approximately 0.1 wt % to approximately 2 wt % of the total weight of the cleaning solution. The cleaning solution may include more than one surfactant, or two cleaning solutions including two different surfactants may be used sequentially. The surfactant may be anionic, cationic, non-ionic, zwitterionic, polymeric, or an organic acid. By way of non-limiting example, the surfactant may include alkyl benzene sulfonates, polyethoxylates, polyacrylates, polyetylene glycol, polyvinyl pyrrolidone and surfactant/polymer blends thereof. In one embodiment, the cleaning solution includes both an anionic and a cationic surfactant. It is believed that the mixed surfactant systems may be used to create a synergistic enhancement of the activity of each surfactant. In one embodiment, ionic surfactants may be mixed with non-ionic species to improve the cleaning efficiency.

The surfactant may be a surfactant based on polycarboxylate polymer chemistry, such as the SOKALAN® series of surfactants, which are available from BASF Corporation (Florham Park, N.J.). In one embodiment, the surfactant is SOKALAN® CP 12 S which is a maleic acid-acrylic acid copolymer. SOKALAN® CP 12 S is a proprietary surfactant blend that is believed to include 2% (w/w) hydrogen peroxide, 50% (w/w) water (CAS No. 7732-18-5) and 48% (w/w) poly(acrylic acid-comaleic acid) (CAS No. 29132-58-9).

The cleaning solution may exhibit a pH of between about 2 and about 10. In one embodiment, the cleaning solution has a pH of approximately 4. In one embodiment, the cleaning solution has a pH of approximately 2 and in another embodiment the cleaning solution has a pH of approximately 7. The pH of the cleaning solution may be adjusted by adding conventional pH adjusters to the solution including, but not limited to, potassium hydroxide, ammonium hydroxide, trimethyl ammonium hydroxide (TMAH), potassium carbonate, sulfuric acid, nitric acid, phosphoric acid, citric acid, and oxalic acid. In one embodiment, the cleaning solution includes 2 wt % H₂O₂, 1 wt % polyacrylic acid, 0.5 wt % TMAH, and 96.5 wt % DI water.

As understood by those of ordinary skill in the art, the surfactant may be selected after considering the particular contamination type (e.g., slurry, organic etc.), solution pH and hydrophobic surface 24 to be cleaned. Similarly, the pH may be selected for use with a particular surfactant, debris 8 and hydrophobic surface 24 system. If an anionic surfactant is used, the anionic surfactant will absorb to organic debris 8, to render the organic material water soluble, and provide a charge to the organic debris 8 which will prevent re-deposition of the organic debris 8 onto the hydrophobic surface 24. By adjusting the pH of the cleaning solution and surfactant selection, the organic debris 8 may be charged such that the organic debris 8 and hydrophobic surface 24 mutually repel each other. Since the isoelectric point for conventional post-CMP debris 8 will be known, i.e., at a known pH, the debris 8 will not exhibit a charge. However, if the pH is adjusted above or below the isoelectric point, the debris 8 will exhibit a charge. Thus, the pH of the cleaning solution may be adjusted so that the debris 8 and the hydrophobic surface 24 have the same charge and the debris 8 is repelled from the hydrophobic surface 24 minimizing redeposition from the bulk solution.

The semiconductor wafer 20 may be exposed to the cleaning solution at an ambient temperature of approximately 25° C. and for a sufficient amount of time to remove the debris 8. The exposure time may depend on the amount of debris 8 on the hydrophobic surface 24. The exposure time may range from approximately 5 seconds to approximately 1 minute. In one embodiment, the exposure time is approximately 20 seconds.

The debris 8 may be removed from the hydrophobic surface 24 by contacting the semiconductor wafer 20 with the cleaning solution. For the sake of example only, the cleaning solution may be applied by spin-cleaning, immersion cleaning or by spray-cleaning. In one embodiment, the semiconductor wafer 20 to be cleaned is placed on a platen and the cleaning solution flowed thereover at a flow rate of from approximately 150 ml/minute to approximately 300 mL/minute during a buff rinse or at a lower flow rate with “on platen” dilution with DI water. During the buff rinse, the hydrophobic surface 24 is “polished” or “buffed” using soft pads while the cleaning solution is flowed thereover. In one embodiment, the semiconductor wafer 20 may be exposed to the cleaning solution in the absence of brushes.

In one embodiment, the semiconductor wafer 20 is immersed in the cleaning solution. The semiconductor wafer 20 may be placed in a tank, such as a stainless steel tank containing a sufficient volume of the cleaning solution to completely immerse the semiconductor wafer 20. For sake of example only, the cleaning solution may circulate from the bottom of the tank to the top of the tank and flow over and across the semiconductor wafer 20 or wafers immersed in the tank. Debris 8 removed from the hydrophobic surface 24 may be filtered or otherwise removed from the cleaning solution so that the cleaning solution may be reused. The tank may be of a sufficient size to accommodate multiple semiconductor wafers 20. Therefore, more than one semiconductor wafer 20 may be cleaned simultaneously and the method of the present invention provides a suitable, easily implemented approach to rapidly removing the debris 8 from the hydrophobic surface 24. For the sake of example only, a rack that holds multiple semiconductor wafers 20 may be immersed in the tank. The tank structure and configuration is not critical to the operability of the present invention and an apparatus employed to implement embodiments of methods of the invention may be a conventional tank that is capable of providing the necessary vibrational energy and temperature environment. For the sake of example only, the tank may include variable temperature settings that enable the temperature of the cleaning solution to be adjusted. The tank may also include a vibrational source configured to provide variable frequency vibrational energy settings to the tank and cleaning solution therein. For sake of example only, the vibrational source associated with the tank may have vibrational energy power settings of from approximately 0 Watts to approximately 1000 Watts. Currently, it is believed that a vibrational energy power of from approximately 500 Watts to approximately 700 Watts is efficacious for practicing the present method.

In another embodiment, the semiconductor wafer 20 is sprayed with the cleaning solution to remove the debris 8. The semiconductor wafer 20 may be rotated during spraying, such as from approximately 300 revolutions per minute (“rpm”) to approximately 800 rpm. The cleaning solution may contact the semiconductor wafer 20 by directing a spray, such as a high-pressure jet spray or a high-velocity aerosol spray, of the cleaning solution at the semiconductor wafer 20. For sake of example only, the high-pressure jet spray may be generated using a spray nozzle that includes a fine orifice and a pump. Such nozzles are known in the art and are not described in detail herein. The high-velocity aerosol spray may be generated using a spray nozzle that includes a concentric or crossflow nebulizer. The high-velocity aerosol spray may include a carrier gas in addition to the cleaning solution. However, it is understood that other techniques of forming the spray may be used, as known in the an. The spray of cleaning solution may be delivered in any configuration, such as a needle spray or a fan spray. A pressure at which the cleaning solution is applied to the semiconductor wafer 20 may be sufficient to remove the debris 8. For the sake of example only, if a high-pressure jet spray is used, the pressure may range from approximately 50 MPa to approximately 200 MPa. If a high-velocity aerosol spray is used, the spray velocity may range from approximately 50 mL/min to approximately 200 mL/min. The semiconductor wafer 20 may be exposed to the spray for a sufficient amount of time to remove the debris 8.

It is also contemplated that the semiconductor wafer 20 may be vibrated, such as at an ultrasonic or megasonic frequency, during cleaning. As previously mentioned, the cleaning solution may also be sprayed through an ultrasonic nozzle or a megasonic nozzle. It is also contemplated that the semiconductor wafer 20 may be exposed to an additional cleaning process before, during, or after it has been exposed to the cleaning solution. For the sake of example only, the semiconductor wafer 20 may be exposed to the vibrational energy before, during, or after it has been sprayed to assist in removing the debris 8.

As shown in FIG. 1B, the amount of debris 8 remaining on the hydrophobic surface 24 after the cleaning may be reduced or substantially eliminated compared to the amount of debris 8 present before the cleaning. The cleaning solution of the present invention effectively removes debris 8, including organic debris, planarized surface material(s) and slurry particulate in a single act. For the sake of example only, using the cleaning solution may reduce the amount of debris 8 on the hydrophobic surface 24 by 15% as compared to conventional deionized water (DI water) cleans. In one embodiment, using the cleaning solution may reduce the amount of debris 8 on the semiconductor wafer 20 by approximately 37% in comparison to that remaining after a DI water clean, while in others embodiments, using the cleaning solution may reduce the amount of debris 8 by more than 50% or even by approximately 64% or more.

In addition to removing the debris 8 from the hydrophobic surface 24, the cleaning solution applied in accordance with the present invention may have little or no adverse effect on exposed structures present on the semiconductor wafer 20. In other words, the cleaning solution does not damage these structures.

Conventional post-CMP cleans include a deionized water rinse or buff rinse followed by a series of cleaning steps which may include a brush box megasonic cleaning and/or spin-rinse dry steps. The brush box may include acids and bases such as HF and TMAH. Selection of the chemistry will be determined by the slurry particle being used in the polish and the type of surface being cleaned. It is contemplated that embodiments of the cleaning method of the present invention may be used instead of the deionized water rinse and may be followed by conventional processing including, for example, brush box treatment. Cleaning of the hydrophobic surface 24 with an oxidizing agent and surfactant of the present invention may result in reduced time spent in the brush box and other post-CMP cleans and enhance semiconductor wafer 20 throughput. Further, by oxidizing the hydrophobic surface 24 with the oxidizing agent, the hydrophobic surface 24, such as polysilicon or single crystal silicon, may be protected from attack by TMAH used in a subsequent brush box clean.

While the methods and compositions of the present invention have been described with respect to post-CMP processing, it will be understood that the methods and compositions may be used at any time during semiconductor fabrication. For example, the present invention may be used to clean the hydrophobic surface 24 after wet clean processes. Water spots will often form on a hydrophobic surface 24 after a wet clean. By flowing a cleaning solution including a surfactant and an oxidizing agent over the semiconductor wafer 20 after a wet clean, the hydrophobic surface 24 will be passivated, enabling the treated semiconductor wafer 20 to dry without water spots.

The invention may be further understood by the following non-limiting examples.

### EXAMPLES

### Example 1

### Effect of Cleaning Solutions on Removing Debris from Patterned Semiconductor Wafers

Patterned semiconductor wafers 20 having post-CMP debris 8 thereon were exposed to a variety of cleaning solutions. The cleaning solutions included 1) deionized water (control); 2) 30 wt % H₂O₂ in deionized water (150 ml H₂O₂ in 2350 ml deionized water); 3) 30 wt % H₂O₂ and 25 wt % TMAH in DI water (150 mL H₂O₂ and 150 mL TMAH in 2200 mL deionized water); and 4) 30 wt % H₂O₂, 25 wt % TMAH and 48 wt % SOKALAN® CP 12 S in DI water (150 mL H₂O₂, 150 mL TMAH and 50 mL SOKALAN® CP 12 S in 2150 mL DI water). The semiconductor wafers 20 were placed on a platen and the cleaning solution was flowed over the semiconductor wafers for 20 seconds. The semiconductor wafers 20 were inspected using optical scanners and the amount of debris 8 on the hydrophobic surfaces 24 was quantified. The amount of debris 8 was then normalized against the DI water run.

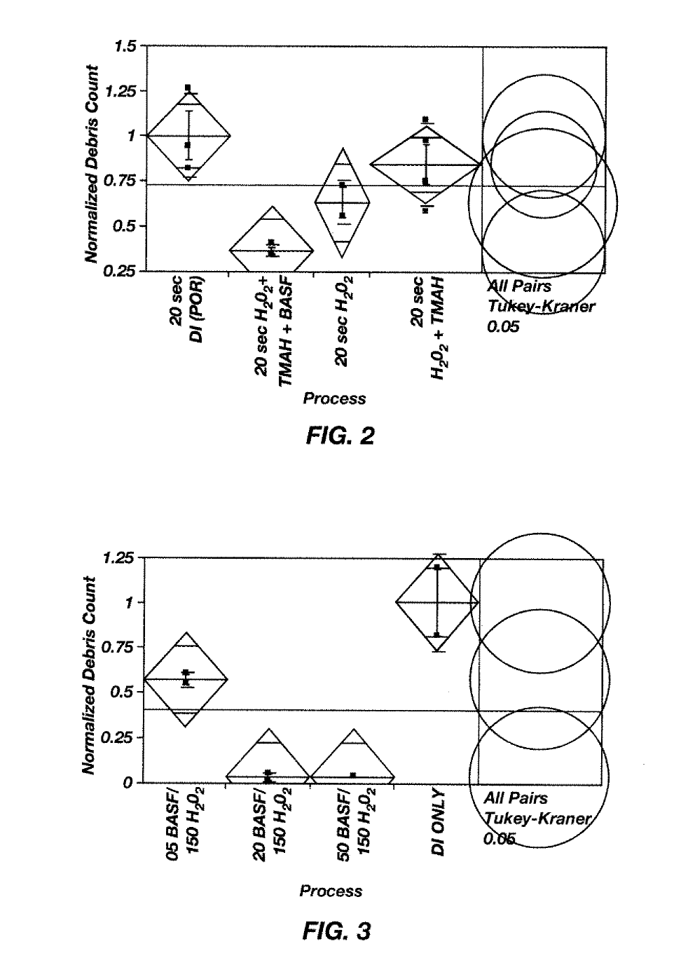

As shown in Table 1 and FIG. 2 the semiconductor wafers 20 exposed to the cleaning solution including the oxidizing agent and the surfactant had the lowest number of debris compared to both the semiconductor wafer 20 exposed to the control cleaning solution and the semiconductor wafers 20 exposed to 30 wt % H₂O₂ or 30 wt % H₂O₂ and 25 wt % TMAH.

TABLE 1
Reduction in Surface Debris Using Various Cleaning Solutions at a
Constant 25° C. Temperature.

| | Reduction of |
|---|---|
| Cleaning Solution | Surface Debris (%) |
| DI Water | 0 |
| DI Water + H₂O₂ | 37 |
| DI Water + H₂O₂ + TMAH | 15 |
| DI Water + H₂O₂ + TMAH + | 64 |
| SOKALAN ® CP 12 S | |

### Example 2

### Effect of Cleaning Solutions Including Varying Concentrations of Surfactant on Removing Debris from Blanket Semiconductor Wafers

Blanket semiconductor wafers 20 having post-CMP debris 8 were exposed to a variety of cleaning solutions. The effect of varying the surfactant concentration in the cleaning solutions while keeping the concentration of oxidizing agent constant was investigated. The cleaning solutions were flowed over the patterned semiconductor wafers 20 for 20 seconds. The semiconductor wafers 20 were inspected using optical scanners and the amount of debris 8 on the hydrophobic surfaces 24 was quantified. The amount of debris 8 was then normalized against the DI water run.

As shown in Table 2 and FIG. 3, cleaning solutions that included 5 mL, 20 mL and 50 mL of 48 wt % SOKALAN® CP 12 S in 150 mL of 30 wt % H₂O₂ and the appropriate volume of deionized water to reach a final volume of 2500 mL showed reduced contamination levels compared to the control cleaning solution, which lacked SOKALAN® CP 12 S. Debris 8 removal efficiency leveled off when the volume of SOKALAN CP® 12 S used in the cleaning solution was at or above 20 mL. The results demonstrated that SOKALAN® CP 12 S played a significant role in debris 8 removal.

TABLE 2
Contamination Results Using Cleaning Solutions Having Varying
Concentrations of SOKALAN ® CP 12 S with 150 mL
30 wt % H₂O₂, at Ambient Temperature
and Constant pH 4.

| | | Reduction |
|---|---|---|
| | Time | of Surface |
| Cleaning Solution | (sec) | Debris (%) |
| DI water | 20 | 0 |
| 5 mL SOKALAN ® CP 12 S, 150 mL H₂O₂ | 20 | 43 |
| 20 mL SOKALAN ® CP 12 S, 150 mL H₂O₂ | 20 | 97 |
| 50 mL SOKALAN ® CP 12 S, 150 mL H₂O₂ | 20 | 97 |

### Example 3

### Effects of Varying Concentration of Oxidizing Agent and Constant Surfactant Concentration on Debris Removal from a Blanket Semiconductor Wafer

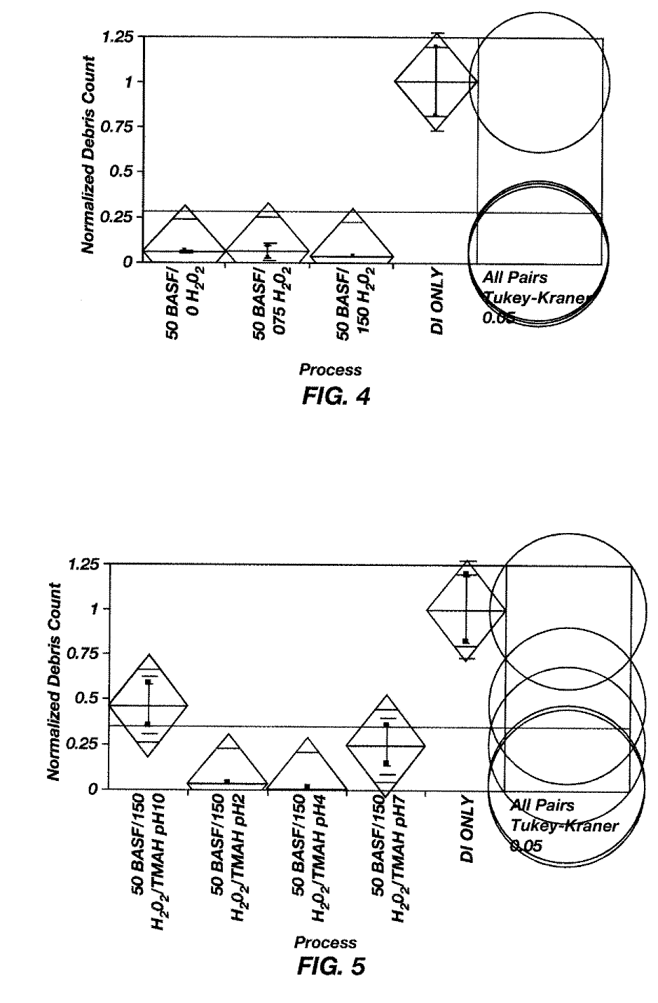

Blanket semiconductor wafers 20 having post-CMP debris 8 were exposed to a variety of cleaning solutions. The amount of debris 8 on the hydrophobic surface 24 was measured after cleaning with a cleaning solution including different ratios of 30 wt % hydrogen peroxide to surfactant. The pH and the surfactant volumes were constant at pH 4 and 50 mL of 48 wt % SOKALAN® CP 12 S with the appropriate volume of DI water to reach a final volume of 2500 mL. The cleaning solutions were flowed over the semiconductor wafers 20 for 20 seconds. The semiconductor wafers 20 were inspected using optical scanners and the amount of debris 8 on the hydrophobic surfaces 24 was quantified. The amount of debris 8 was then normalized against the DI water run. As shown in Table 3 and FIG. 4, debris 8 removal efficiency improved with increased hydrogen peroxide concentration.

TABLE 3
Contamination Results Using Cleaning Solutions Having Varying
Volumes of H₂O₂ with 50 mL Polycarboxylate Surfactant
at Ambient Temperature.

| | | Reduction |
|---|---|---|
| | | of Surface |
| Cleaning Solution | Time (sec) | Debris (%)) |
| DI Water | 20 | 0 |
| 0 mL H₂O₂, 50 mL SOKALAN ® | 20 | 94 |
| CP 12 S | | |
| 75 mL H₂O₂ 50 mL SOKALAN ® | 20 | 93 |
| CP 12 S, | | |
| 150 mL H₂O₂ 50 mL | 20 | 97 |
| SOKALAN ® CP 12 S | | |

### Example 4

### Effect of Cleaning Solutions Having Varying pH with Constant Amount of Oxidizing Agent and Surfactant in Debris Removal from a Blanket Semiconductor Wafer

Blanket semiconductor wafers 20 having post-CMP debris 8 were exposed to a variety of cleaning solutions. Multiple 2500 mL cleaning solutions were prepared by the addition of 150 mL H₂O₂ (30 wt %), 50 mL SOKALAN® CP 12 S (48 wt %) and the appropriate volume of TMAH (25 wt %) to adjust the pH to 2, 4, 7 or 10. The solutions were flowed over semiconductor wafers 20 contaminated with debris 8 for 20 seconds. The semiconductor wafers 20 were inspected using optical scanners and the amount of debris 8 on the hydrophobic surfaces 24 was quantified. The amount of debris 8 was then normalized against the DI water run. As shown in Table 4 and FIG. 5, pH significantly affected debris 8 removal and pH 4 provided the best results for debris 8 removal.

TABLE 4
Contamination Results Using Cleaning Solutions Including Varying pH
and 150 mL H₂O₂ and 50 mL Polycarboxylate Surfactant at
Ambient Temperature.

| | | Reduction of |
|---|---|---|
| pH | Time (sec) | Surface Debris (%) |
| DI Water | 20 | 0 |
| 2 | 20 | 97 |
| 4 | 20 | 90 |
| 7 | 20 | 76 |
| 10 | 20 | 54 |

### Example 5

### Effect of Cleaning Solutions with Varying Time and Constant Surfactant and Oxidizing Agent Concentation in Debris Removal from a Blanket Semiconductor Wafer

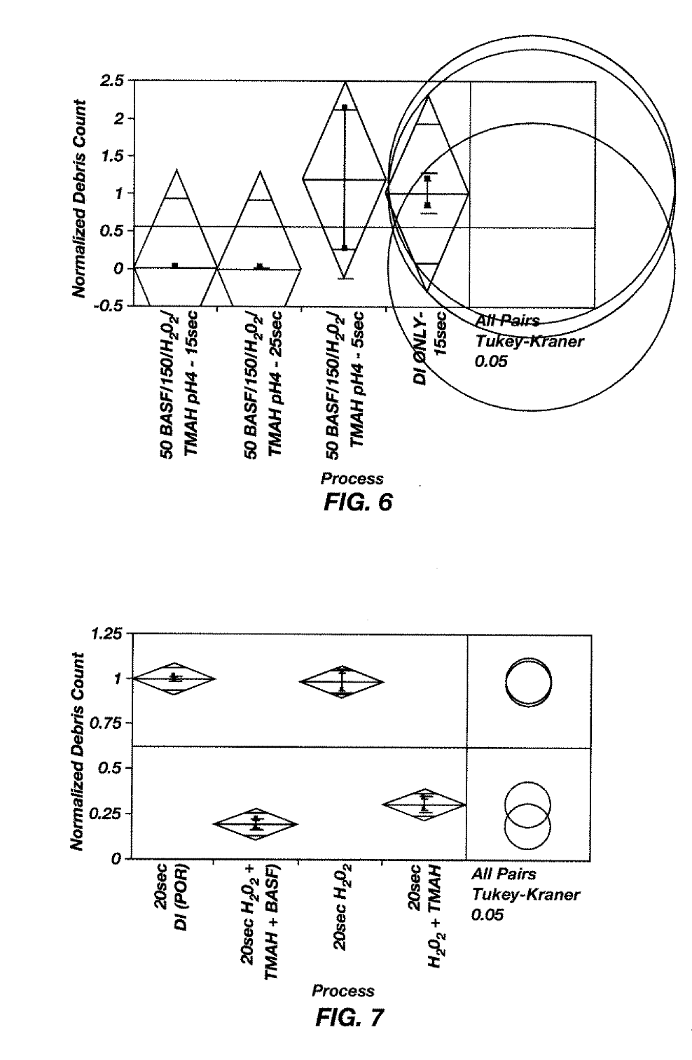

Blanket semiconductor wafers 20 having post-CMP debris 8 were exposed to a variety of cleaning solutions. Semiconductor wafers 20 contaminated with slurry and debris 8 were exposed to a cleaning solution that included 2300 mL DI water, 150 mL H₂O₂ (30 wt %) and 50 mL SOKALAN® CP 12 S (48 wt %). The pH was constant at 4. The cleaning solution was flowed over the semiconductor wafers 20 for 5, 15 or 25 seconds. The semiconductor wafers 20 were inspected using optical scanners and the amount of debris 8 on the hydrophobic surfaces 24 was quantified. The amount of debris 8 was then normalized against the DI water run. As shown in Table 5 and FIG. 6, increased exposure time improved debris 8 removal although, the efficiency leveled off between 15 and 25 seconds.

TABLE 5
Contamination Results Using Cleaning Solutions Including Varying pH
and 150 mL H₂O₂ (30 wt %) and 50 mL polycarboxylate surfactant.

| Time | Temperature | | Reduction of |
|---|---|---|---|
| (seconds) | (° C.) | pH | Surface Debris (%)) |
| 5 | 25 | 4 | 0 |
| 15 | 25 | 4 | 99 |
| 25 | 25 | 4 | 99.5 |

### Example 6

### Effect of Various Cleaning Protocols on Surface Debris on Bare Silicon

Bare silicon process monitor wafers contaminated with slurry and debris 8 were exposed to various cleaning protocols. A first protocol included a 10 second conventional slurry polish and a twenty second DI water buff rinse on a platen. A second protocol included a 10 second slurry polish and a twenty second buff rinse with 2350 mL DI and 150 mL H₂O₂ (30 wt %) on a platen. A third protocol included a 10 second slurry polish, a twenty second buff rinse with 2300 mL DI, 150 mL H₂O₂ (30 wt %) and 50 mL TMAH (25 wt %) on a platen. A fourth protocol included a 10 second slurry polish and a twenty second buff rinse with 2250 mL DI, 150 mL H₂O₂ (30 wt %), 50 mL TMAH (25 wt %) and 50 mL SOKALAN® CP 12 S (48 wt %) on a platen. The semiconductor wafers 20 were inspected using optical scanners and the amount of debris 8 on the hydrophobic surfaces 24 was quantified. The amount of debris 8 was then normalized against the DI water run.

As shown in Table 6 and FIG. 7, the debris 8 counts were the lowest for the cleaning protocol that included SOKALAN® CP 12 S in the cleaning solution.

TABLE 6
Contamination Results Using Various Cleaning Solutions.

| | | Reduction |
|---|---|---|
| | | of Surface |
| | Cleaning Protocol | Debris (%) |
| 1 | 10 sec slurry polish, 20 sec deionized | 0 |
| | water buff on platen | |
| 2 | 10 sec slurry polish and a 20 sec H₂O₂ | 2 |
| | buff on platen | |
| 3 | 10 sec slurry polish and a 20 sec H₂O₂ | 70 |
| | and TMAH buff on platen | |
| 4 | 10 sec slurry polish and a 20 sec H₂O₂ | 81 |
| | TMAH and SOKALAN ® CP 12 S | |
| | buff on platen | |

The invention is susceptible to various modifications and alternative forms in addition to specific embodiments shown by way of example in the drawings and described in detail herein. Thus, the invention is not limited to the particular forms disclosed. Rather, the scope of the invention encompasses all modifications, equivalents, and alternatives falling within the following appended claims.

1. A method of cleaning a semiconductor wafer of organic debris resulting from an abrasive process, the method comprising exposing a hydrophobic surface of a semiconductor wafer to a cleaning solution substantially free of ammonia and comprising an oxidizing agent and at least one polycarboxylate surfactant to remove the organic debris.

2. The method of claim 1, further comprising selecting the oxidizing agent from the group consisting of periodates, perbromates, perchromates, pernitrates, perchlorates, hydrogen peroxide, organic peroxides, and persulfates.

3. The method of claim 1, wherein exposing a hydrophobic surface of a semiconductor wafer to a cleaning solution comprises exposing a hydrophobic surface of a semiconductor wafer to a cleaning solution having a pH of approximately 4.

4. The method of claim 1, wherein exposing a hydrophobic surface of a semiconductor wafer to a cleaning solution comprises exposing a hydrophobic surface selected from the group consisting of polysilicon, single crystal silicon and a dielectric resin.

5. The method of claim 1, wherein exposing a hydrophobic surface of a semiconductor wafer to a cleaning solution comprising an oxidizing agent comprises exposing a hydrophobic surface of a semiconductor wafer to a cleaning solution comprising the oxidizing agent from approximately 1% by weight of a total weight of the cleaning solution to approximately 5% by weight of the total weight of the cleaning solution.

6. The method of claim 1, wherein exposing a hydrophobic surface of a semiconductor wafer to a cleaning solution comprises exposing a hydrophobic surface of a semiconductor wafer to a cleaning solution comprising a polycarboxylate surfactant from approximately 0.1% by weight of a total weight of the cleaning solution to approximately 2% by weight of a total weight of the cleaning solution.

7. The method of claim 1, wherein exposing a hydrophobic surface of a semiconductor wafer to a cleaning solution comprising an oxidizing agent and at least one polycarboxylate surfactant comprises exposing a hydrophobic surface of a semiconductor wafer to a cleaning solution for approximately twenty seconds.

8. The method of claim 1, wherein the hydrophobic surface is nonmetallic.

9. The method of claim 1, wherein the at least one polycarboxylate surfactant comprises poly(acrylic acid-co-maleic acid).

10. The method of claim 1, wherein exposing a hydrophobic surface of a semiconductor wafer to a cleaning solution including an oxidizing agent and at least one polycarboxylate surfactant comprises reducing the amount of debris on the hydrophobic surface by more than 50%.

11. A method of removing organic debris from a hydrophobic surface, the method comprising:
oxidizing a hydrophobic surface having organic debris thereon by exposing the hydrophobic surface to a solution substantially free of hydrogen fluoride and ammonia;
exposing the hydrophobic surface to a surfactant; and charging the organic debris such that the hydrophobic surface and organic debris exhibit a similar electrical charge to remove the organic debris from the hydrophobic surface.

12. The method of claim 11, wherein oxidizing a hydrophobic surface having organic debris thereon comprises exposing the hydrophobic surface to a solution comprising an oxidizing agent.

13. The method of claim 11, wherein oxidizing a hydrophobic surface having organic debris thereon comprises exposing the hydrophobic surface to a solution including an oxidizing agent selected from the group consisting of periodates, perbromates, perchromates, pernitrates, perchlorates, hydrogen peroxide, organic peroxides, and persulfates.

14. The method of claim 11, wherein exposing the hydrophobic surface to a surfactant comprises exposing the hydrophobic surface to a solution comprising a polycarboxylate surfactant.

15. The method of claim 11, wherein charging the organic debris such that the hydrophobic surface and the organic debris exhibit a similar electrical charge comprises exposing the hydrophobic surface to a solution comprising at least one surfactant selected from the group consisting of anionic, cationic, non-ionic, zwitterionic, polymeric, or an organic acid surfactant.

16. The method of claim 11, further comprising repelling the organic debris from the hydrophobic surface responsive to the similar electrical charges of the organic debris and the hydrophobic surface.

17. The method of claim 11, further comprising applying vibrational energy to the hydrophobic surface.

18. The method of claim 11, wherein oxidizing a hydrophobic surface comprises oxidizing a nonmetallic surface.

19. The method of claim 11, wherein oxidizing a hydrophobic surface comprises oxidizing a surface selected from the group consisting of polysilicon, single crystal silicon and a dielectric resin.

20. A composition comprising:
at least one anionic surfactant at from approximately 0.1% by weight of a total weight of the composition to approximately 2% by weight of the total weight of the composition;
an oxidizing agent at from approximately 1% by weight of the total weight of the composition to approximately 5% by weight of the total weight of the composition; and water.

21. The composition of claim 20, wherein the composition comprises 1% by weight of polyacrylic acid, 2% by weight of hydrogen peroxide, 0.5% by weight of TMAH and 96.5% by weight of deionized water based on the total weight of the composition.
